(19) United States
(12) Patent Application Publication
(10) Pub. No.: US 2017/0236555 A1
(43) Pub. Date: Aug. 17, 2017

(54) TAPE LIBRARY CONTAINER

(71) Applicant: Spectra Logic Corporation, Boulder, CO (US)

(72) Inventors: David Lee Trachy, Longmont, CO (US); Scott Edward Bacom, Broomfield, CO (US); Nathan Christopher Thompson, Boulder, CO (US)

(73) Assignee: Spectra Logic Corporation, Boulder, CO (US)

(21) Appl. No.: 15/431,712

(22) Filed: Feb. 13, 2017

Related U.S. Application Data
(60) Provisional application No. 62/434,407, filed on Dec. 14, 2016.
(60) Provisional application No. 62/294,282, filed on Feb. 11, 2016.

(51) Int. Cl. G11B 33/04; B65D 88/54; B65D 88/12; B65D 90/02; G11B 15/675; B65G 1/04

(52) U.S. Cl. CPC G11B 33/04; G11B 15/675; B65G 1/04; B65D 88/12; B65D 90/02; B65D 88/54

(57) ABSTRACT

Aspects of the invention described here are directed to a tape library that is constructed within an integrated with a standard freight/shipping container to form a freight/shipping container tape library. The freight/shipping container library can be assembled at a manufacturing site, loaded with tape media, equipped with the tape drives, provided with robotic transporters and all the necessary computing systems, wiring, and electronics to fully function as a storage system when transported to an end user location.

### CROSS-REFERENCE TO RELATED APPLICATIONS

This application is a non-provisional application which claims priority to and the benefit of U.S. Provisional Patent Application Ser. No. 62/434,407, entitled TAPE LIBRARY CONTAINER filed Dec. 14, 2016, the entire disclosure of which is hereby incorporated by reference and U.S. Provisional Patent Application Ser. No. 62/294,282, entitled ENVIRONMENTALLY CONTROLLED LIBRARY filed Feb. 11, 2016, the entire disclosure of which is hereby incorporated by reference.

### BACKGROUND OF THE INVENTION

Field of the Invention

The present embodiments are directed to a tape library that is integrated in a shipping container.

Description of Related Art

Tape libraries provide significant data storage with minimal power requirements. The tape libraries do not possess the speed and random access nature of disk drives and solid state memory, they are inexpensive and can be stored without power for significant period of time. Presently, tape libraries are built with drives and shelf systems on a rack, or frame, and then covered with a housing. Some tape libraries are module where they are essentially constructed as tape library cabinets whereby multiple other tape library cabinets can be linked together to form a long, multi-cabinet tape library system. When installed, the tape library cabinets can be easily linked to one another at a final storage facility destination. Most storage facilities put the tape library cabinets in air conditioned environments to manage heat levels generated by power consuming elements in the tape library cabinets. These facilities are typically air-conditioned data centers, which are large air-conditioned rooms or warehouses. Some data cartridge libraries further provide some level of climate control using fans that suck cool air from air-conditioned environments, as done in McKinley, U.S. Pat. No. 6,676,026.

It is to innovations related to this subject matter that the claimed invention is generally directed.

### SUMMARY OF THE INVENTION

The present embodiments are directed to a tape library that is integrated in a shipping container.

Embodiments of shipping container tape library storage systems can generally comprise a shipping container that houses an integrated tape library system. The library system being built inside of the shipping container. Though a shipping container is generally made of steel, certain embodiments further envision aluminum, wood or other suitable external material to support the embodiments described herein. Embodiments contemplate a shipping container storage system possessing power ports that are adapted to connect to power supplied from outside of the shipping container. Power supplied via the power ports provide power to the internal power using elements within the shipping container storage system. Shipping container integrated tape library storage systems allow for rapid deployment of tape libraries, which provide inexpensive, low power, dense storage that can be used for archive storage purposes. It is envisioned that shipping container integrated tape library storage systems can be shipped to a final destination and simply be plugged in to power and data transfer lines where the storage systems can be up and running with little effort. Because the shipping containers can easily be environmentally sealed, the tape library components within them can be protected from environmental elements. Moreover, temperature and humidity control can be easily integrated within the container storage system.

### BRIEF DESCRIPTION OF THE DRAWINGS

FIG. 1 artistically depicts an example of a populated tape magazine and tape drive used consistently with various embodiments of the present invention

FIG. 2A is a side view of a shipping container library embodiment revealing some of the inner elements within the shipping/freight container library embodiment consistent with embodiments of the present invention.

FIG. 2B is a top view of the shipping container library embodiment of FIG. 2A revealing (through the top) some of the inner elements within the shipping/freight container library embodiment consistent with embodiments of the present invention.

FIG. 2C is a top view of the shipping container library embodiment of FIG. 2A with front and back doors revealing (through the top) some of the inner elements within the shipping/freight container library embodiment consistent with embodiments of the present invention.

FIG. 2D is a perspective view of the freight/shipping container library embodiment similar to FIG. 2A revealing (through the cutaway section) some of the inner elements within the shipping/freight container library embodiment consistent with embodiments of the present invention.

FIG. 3 is a block diagram method embodiment teaching a basic construction of the freight/shipping container library consistent with embodiments of the present invention.

FIG. 4A is a block diagram of a side view of the freight/shipping container library embodiment revealing the internal region of a robotic transporter consistent with embodiments of the present invention.

FIG. 4B illustratively depicts the robotic transporter stirring up the air inside of the freight/shipping container library consistent with embodiments of the present invention.

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in other types of tape related libraries built in a shipping container/pre-existing housing. In what follows, similar or identical structures may be identified using identical callouts.

Described below are embodiments of shipping container storage systems that generally comprise a shipping container that houses an integrated tape library system. The library system being built inside of the shipping container. Though a shipping container is generally made of steel, certain embodiments further envision aluminum, wood or other suitable external material to support the embodiments described herein. Embodiments contemplate a shipping container storage system possessing power ports that are adapted to connect to power supplied from outside of the shipping container. Power supplied via the power ports provide power to the internal power using elements within the shipping container storage system. Shipping container integrated tape library storage systems allow for rapid deployment of tape libraries, which provide inexpensive, low power, dense storage that can be used for archive storage purposes. It is envisioned that shipping container integrated tape library storage systems can be shipped to a final destination and simply be plugged in to power and data transfer lines where the storage systems can be up and running with little effort. Because the shipping containers can easily be environmentally sealed, the tape library components within them can be protected from environmental elements. Moreover, temperature and humidity control can be easily integrated within the container storage system.

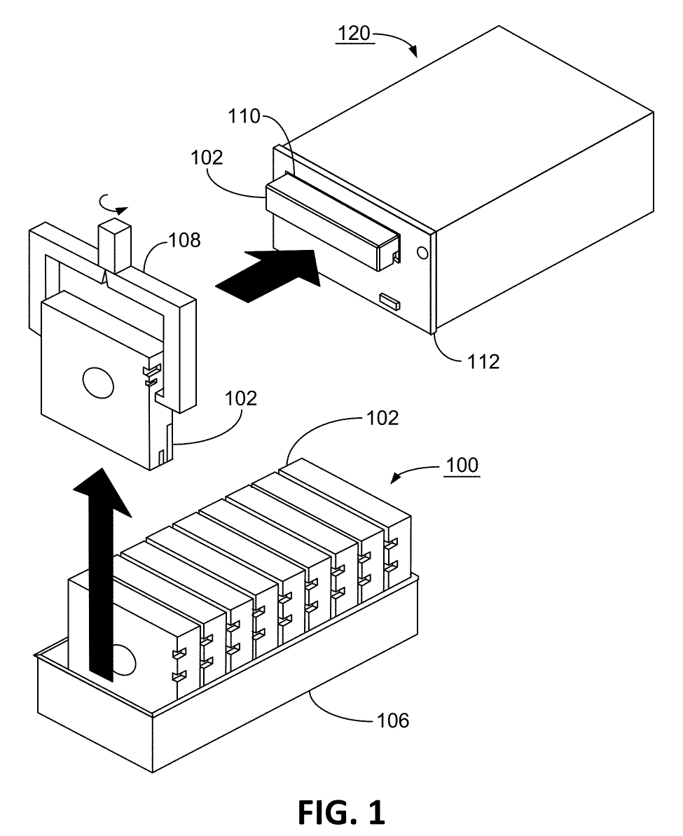

FIG. 1 artistically depicts an example of a populated tape magazine 100 and tape drive 120 that can be used in various embodiments described below. As shown, a tape magazine 106 is capable of supporting ten tape cartridges 102 whereby one of the tape cartridges 102 has been removed by a picker apparatus 108 depicted by the vertical arrow. The picker apparatus 108 is an artistic version of a device that is adapted to grasp a tape cartridge 102 and insert the tape cartridge 102 into an opening 110 in the face 112 of a tape drive. When a tape cartridge 102 is inserted in a tape drive 120 as depicted by the horizontal arrow, a cooperating data transfer relationship can be formed (i.e. tape cartridge 102 is “loaded” in the tape drive 120) such that user data can be read from or written to the tape cartridge 102. Though the tape cartridge magazine 106 is depicted as having slots for ten tape cartridges 102, other tape cartridge magazines are envisioned to hold more or less tape cartridges 102 without departing from the scope and spirit of the present invention. An example of a tape cartridge 102 can be an LTO-8 tape cartridge that cooperates with an LTO tape drive, manufactured by IBM of Armonk N.Y.

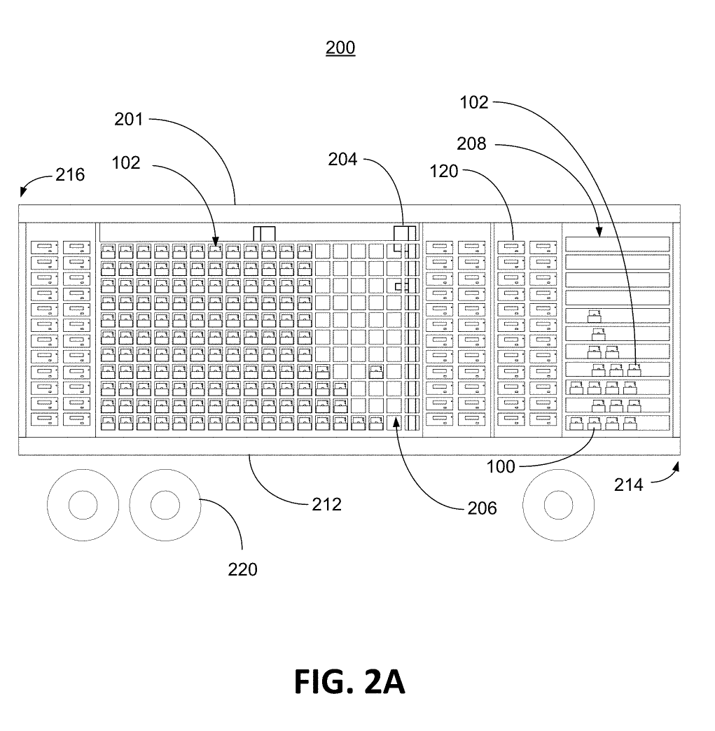

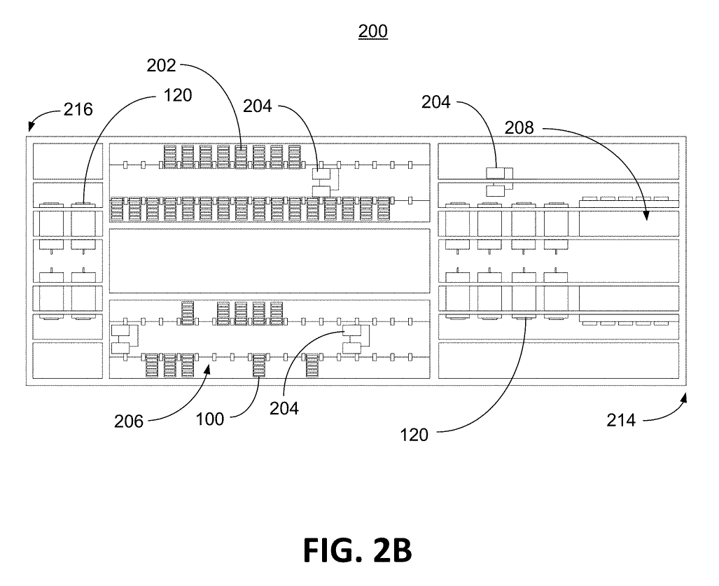

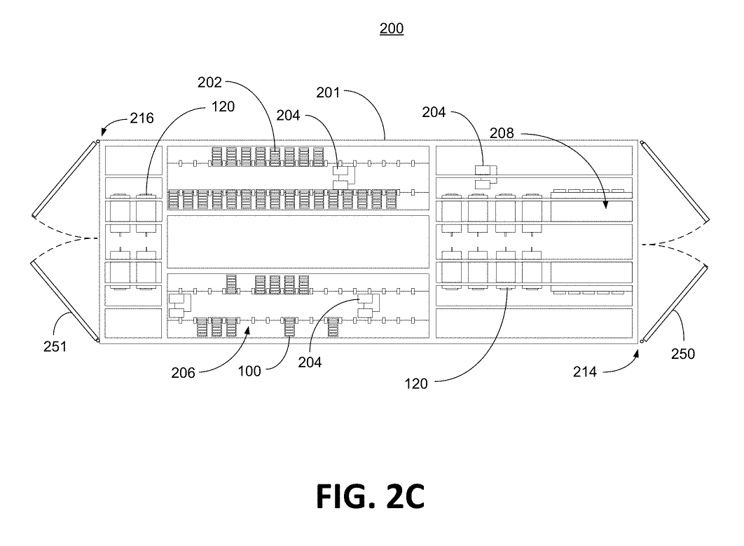

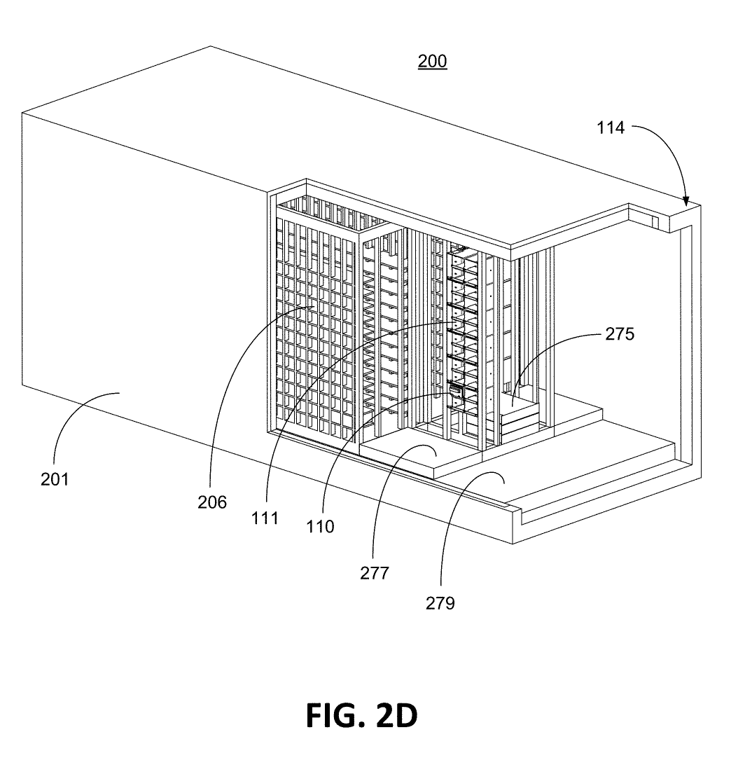

FIG. 2A is a side view of a shipping container library embodiment revealing some of the inner elements within the shipping/freight container library embodiment consistent with embodiments of the present invention. Certain embodiments contemplate the shipping container 212 having dimensions being the standard size of generic shipping containers, such as 8 feet wide, 8.5 feet high, and 20 foot and 40 foot lengths. Other standard heights can include 9.5 feet high for standard tall shipping containers. As illustratively depicted, the freight/shipping container library 200 is specifically adapted to be moved as any standard freight container by trucking (see wheels 220), shipping, train, and other standard means of transporting freight containers. In the present embodiment, there is one bank of tape drives 210 located at the shipping container rear 216, and two banks of tape drives 210 located near the shipping container front 214. A shelf system 206 supports a plurality of tape cartridges 102, which in the present embodiment are disposed in tape cartridge magazines 100. The tape cartridges 102 are transported between the shelf system 206 and tape drives 120 by way of a robotic transporter 204. The robotic transporter 204 possesses a picker device that can grasp a tape cartridge 102 and insert the tape cartridge 104 in a tape drive 120. As further depicted, at the shipping container front 214 is a holding area 208 for tape cartridge 102 entry and exit into the tape library shelf system 206. The entry/exit holding area 208 provides a space for tape cartridges 102 to be introduced into the freight/shipping container library 200 (typically by an operator) whereby the robotic transporter 204 can move the newly introduced tape cartridge/s 102 to the shelf system 206.

FIG. 2B is a top view of the shipping container library embodiment of FIG. 2A revealing (through the top) some of the inner elements within the shipping/freight container library embodiment 200 consistent with embodiments of the present invention. As shown from this view, there is one bank of tape drives 210 located at the shipping container rear 216, and two banks of tape drives 210 located near the shipping container front 214. The shelf system 206 supports the plurality of tape cartridges 102, which in the present embodiment are disposed in tape cartridge magazines 100. The tape cartridges 102 are transported between the shelf system 206 and tape drives 120 by way of a robotic transporter 204. The robotic transporter 204 possesses a picker device 108. As further depicted, at the shipping container front 214 is a holding area 208 for tape cartridge 102 entry and exit into the tape library shelf system 206. The entry/exit holding area 208 provides a space for the tape cartridges magazines 100 to be introduced into the freight/shipping container library 200 (typically by an operator) whereby the robotic transporter 204 can move the newly introduced tape cartridge/s 102 to the shelf system 206.

As depicted in FIG. 2C, the freight/shipping container library 200 can be provided with front access doors 250 and/or rear access doors 251. Certain embodiments contemplate a single door, a roller door, or some other access way to enter the freight/shipping container library 200. Other certain embodiments contemplate the doors being sealed to the environment by any number of means known to those skilled in the art including gaskets, for example. Though the access doors 250 and 251 are depicted on the front 114 and rear 116 of the freight/shipping container library 200, certain embodiments do not limit this placement.

FIG. 2D is a perspective view of the freight/shipping container library embodiment similar to FIG. 2A revealing (through the cutaway section) some of the inner elements within the shipping/freight container library embodiment 200 consistent with embodiments of the present invention. As shown here the freight/shipping container 201 is cutaway to reveal the shelf system 206, the tape drive bays 111 (whereby a tape drive 110 is shown inserted), and optional operator access location 277 (whereby an operator can manually access tape drives 110, HDD or solid-state (or something similar) and an operator access 279. Certain embodiments contemplate a portion of the operator access 279 being used for the entry/exit holding area 208.

FIGS. 2A-2D are illustrative of basic components used to exemplify inventive embodiments in this disclosure. As one skilled in the art will appreciate, the freight/shipping container library 200 will generally include devices and structures not shown in the block illustrations enabling the system 200 to fully function, such as additional controllers (e.g., those controlling other components in the library including the robotic transporter 204), wiring, cooling systems, switch systems, lighting, protocol bridges, etc.

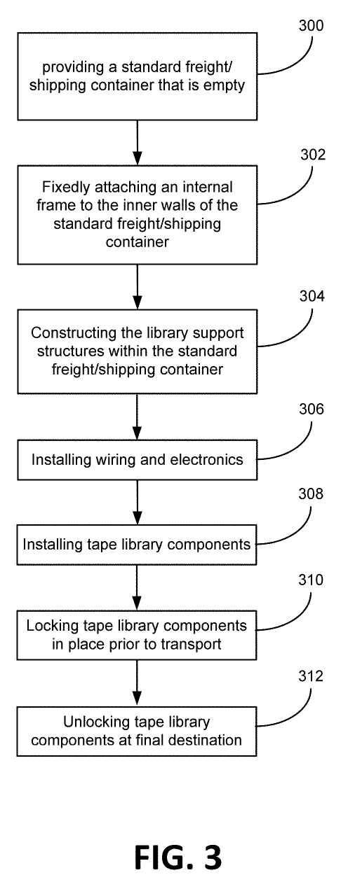

FIG. 3 is a block diagram method embodiment teaching a basic construction of the freight/shipping container library 200 consistent with embodiments of the present invention. In a standard freight/shipping container 201 is provided. Standard shipping/freight containers 201, such as BSL containers headquartered in Hong Kong, are one of a number of manufacturers that meet ISO (International Standards Organization) standards. As such, an empty standard freight/shipping container is provided, step 300. Certain embodiments envision a standard freight/shipping container being provided with a substantially level and rigid housing made out of steel. Some embodiments envision building an internal frame within the standard freight/shipping container 201 to accommodate various library support structures, such as the shelf system 206, rails for the robotic transporter 204, a frame for the tape drives 120, platforms for the holding area 208, etc. that structurally make up the tape library, step 302. The internal frame can further be constructed to improve the rigidity of the standard freight/shipping container 201 and/or bring the standard freight/shipping container 201 into the appropriate tolerances needed for the various library support structures. The internal frame can be fixedly attached to the inner surfaces of the standard freight/shipping container 201, such as by means of bolting, welding, gluing, and the like. Once the internal frame is in place within the standard freight/shipping container 201, the library support structures can be attached to the internal frame and/or the walls of the standard freight/shipping container 201. All appropriate wiring and electronics are generally installed before to installing the library components, such as the robotic transporters 204, the tape drives 120, any hard disk drive (HDD) systems or server's (or optionally those servers comprising solid-state drives (SSD's)), or loading populated tape cartridge magazines 100, and other internal components within the tape library system, step 306. The freight/shipping container library 200 further possesses a computer or Central Processing Unit (CPU), not shown, that houses at least one macro controller that actively cooperates with algorithms that orchestrate actions to components within the freight/shipping container library 201, for example, over a Computer Area Network (CAN), not shown. Because this is essentially a tape library built within a standard freight/shipping container 201 whereby the standard freight/shipping container 201 is an integral part of the tape library and is the outer housing of the tape library, certain embodiments envision the components within the freight/shipping container library 200 being retained by locking systems that are employed during transport of the freight/shipping container library 200, step 310. A magazine latch system embodiment envisions a physical arm or cover that blocks the entry/exit opening of each tape magazine slot in the shelf system 206, thus preventing a populated tape magazine from exiting the entry/exit opening of the shelf system 206. In this way, the freight/shipping container library 200 can be loaded with tape cartridges 102 and an origination location for delivery at a distant location (i.e., the shelf system 206 can be populated with tape cartridge magazines 100 prior to transporting to a final destination) without tape cartridges 102 falling out of the shelf system 206, step 312.

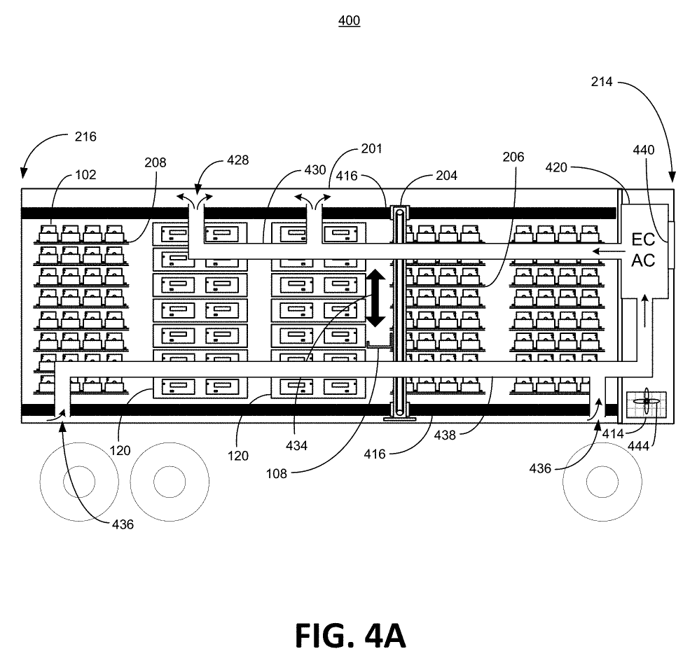

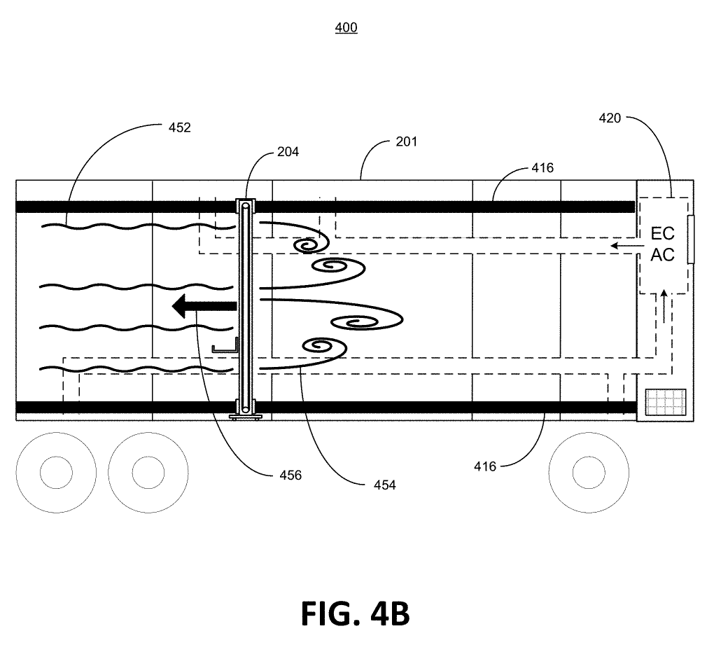

FIG. 4A is a block diagram of a side view of the freight/shipping container library 400 embodiment revealing the internal region of a robotic transporter 204 consistent with embodiments of the present invention. This simplified drawing of the freight/shipping container library 400 depicts a holding area 208 where tape cartridge magazines 100 can be introduced to the freight/shipping container library 400 via an operator. Also depicted are several banks of tape drives 120, followed by the shelf system 206 which supports a plurality of populated tape cartridge magazines 100. The robotic transporter 204 traverses across (front 214 to back 216) the freight/shipping container library 400 along rails 416 in the correct horizontal position of a selected tape cartridge 102 or tape drive 120. Other embodiments contemplate a robotic transporter that moves along a rail system via a belt drive device, a motorized rack and pinion arrangement, a lead screw arrangement, a motor with wheels, etc. The picker device 108 moves vertically (up and down) along the robotic transporter 204 as shown by the arrow 434 to the correct vertical position of the selected tape drive 120 or tape cartridge 102. Tape cartridges 102 house at least one reel and a recording tape medium (not shown), generally magnetic, wound around the reel, whereon data is stored.

As further shown in FIG. 4A, an environmental conditioning system 420, which includes air conditioning, is located at the front end 214 of the freight/shipping container library 400. The air conditioner in the environment conditioning system 420 possesses a heat exchanger 440 that exchanges heat with the environment outside of the freight/shipping container library 400. The environment conditioning system 420 is linked to at least one feed duct 430 and return duct 438. In the present embodiment, feed duct 430 forces air-conditioned air ventilation ports 428 at or near the tape drives 120 while the return duct 438 pulls air from inside of the freight/shipping container library 400 through intake ports 436 located at the ends of the freight/shipping container library 400. The air from inside of the freight/shipping container library 400 moving through the return duct 438 is conditioned at the environmental conditioning system 420 and recirculated into the freight/shipping container library or hundred through the feed duct 430 at the appropriate temperature, humidity, and pressure. Also, as shown here, the feed duct ventilation ports 428 are disposed along the top of the freight/shipping container library 400 and the return duct intake ports 436 are located along the bottom of the freight/shipping container library 400. Certain embodiments contemplate the duct work 430 and 438 contained within the freight/shipping container library 400. Other embodiments envision at least one filter 414 that maintains particulate levels inside of the freight/shipping container library 400 lower than the environment outside of the freight/shipping container library 400. Some embodiments contemplate the freight/shipping container library 400 maintain at a positive pressure relative to the environment outside of the freight/shipping container library 400, which can be maintained by a positive pressure pump 444 (pump or fan, for example). Certain other embodiments envision the freight/shipping container library 400 being essentially sealed from the outside environment. While some embodiments contemplate a heating unit (not shown) included in the environmental conditioning system 420. Other embodiments contemplate using heat generated from the tape drives 120, or other heat generating componentry within the freight/shipping container library 400 that generate heat. Certain other embodiments contemplate the use of both a heating unit and heat generated from heating generating componentry within the freight/shipping container library 400. It is envisioned that the freight/shipping container library 400 can comprise a graphical user interface (not shown), either externally mounted to the freight container 201 or internal to the freight container 201 that an operator can input instructions to manage and/or monitor the ongoing within the freight/shipping container library 400. Certain other embodiments envision a light source mounted along the side or top of the freight container 201 to display messages, location of robotic transporters 204, library status, etc.

FIG. 4B illustratively depicts the robotic transporter 204 stirring up the air inside of the freight/shipping container library 400 consistent with embodiments of the present invention. An internal view of the freight/shipping container library 400 is shown with extraneous elements, such as tape drives 120, tape cartridges 102, shelves 206 and 208, etc., removed for ease of explanation. This embodiment contemplates the robotic transporter 204 moved across the freight/shipping container library 400 from right to left as indicated by the arrow 456 to break up temperature gradients 452 that may form within the freight/shipping container library 400. As the robotic transporter 204 traverses the rails 416, turbulent air 454 disrupts any formation of temperature gradients 452 effectively mixing the air inside of the freight/shipping container library 400 to maintain a more uniform temperature therein. One method envisioned is when the freight/shipping container library 400 has not been used to access a tape cartridge 102 in a while, after a set amount of time, such as a half an hour, for example, the robotic transporter 204 traverses from one end of the freight/shipping container library 400 to the other. It is contemplated that an operator of the freight/shipping container library 400 can input how much time can lapse before the robotic transporter 204 traverses across the freight/shipping container library 400. Certain embodiments contemplate the robotic transporter 204 traversing rapidly, such as 4 feet per second, while other embodiments contemplate the robotic transporter 204 traversing slowly, such as ½ a foot per second. Certain embodiments contemplate the robotic transporter 204 traversing the full-length of the freight/shipping container library 400 if the robotic transporter 204 only moves small distances in a confined area, for example. Other embodiments contemplate the robotic transporter 204 traversing the freight/shipping container library 400 partially, in some predefined sequence of travel (e.g., 25% left, 40% right, 60% left, and so on). Some embodiments contemplate temperature sensors near the floor and near the ceiling of the freight/shipping container library 400 whereby the robotic transporter 204 can be made to traverse the freight/shipping container library 400 if there is a substantial difference in temperature detected between the floor and the ceiling of the freight/shipping container library 400.

An embodiment of the present invention can be commercially practiced with a freight container library produced by Spectra Logic Corporation of Boulder, Colo. In that library, Spectra Logic uses a 10 slotted tape cartridge magazine they call a Terapack. Spectra Logic's freight container library can be constructed with a single tape cartridge type, such as an LTO-8 tape cartridge that can form in a cooperating read and write relationship with an LTO-8 tape drive, or a plurality of different kinds of tape cartridges that can cooperate with compatible tape drives built into the tape drive bays 111. Spectra Logic freight container library can also contain servers that can be used to buffer or provide short-term memory before transferring to the tape cartridges, such as a Spectra Logic Black Pearl or White Pearl server/controller. Because shipping containers are somewhat weatherproof, they can easily be manipulated to be essentially completely weatherproof. In addition to being weatherproof, certain other embodiments contemplate an airlock that seals the library from the exterior environment. The temperature within the tape library container can be managed with HVAC to ensure the tape library components stay within an acceptable temperature range. Other environmental controls can include humidity control to ensure the tape library components stay within an acceptable humidity range. Some embodiments contemplate a service area that can be used as an airlock when not used as a service area at the front and/or back of the shipping container library system. The HBA hookups can include water chilled systems, refrigerants, or open ventilation, just to name a few options.

Because the Spectra Logic freight container library can stand alone and exist in an external environment, temperature and humidity tape is controlled. For example, tape cartridges 102 are subject to failure above or below operating temperatures, such as temperatures above 110° F. or below 32° F. Moreover, certain scenarios envision that the tape library shipping container system is put in a quiescent state when the system is filled with data, that is when essentially all of the tape cartridges are mostly used or considered fully used. In this scenario, the tape library shipping container system is essentially turned off unless archive data therein needs to be recalled. Because over time the tape cartridges themselves may degrade if the temperature within the tape library shipping container system exceeds or falls below the limits of storage temperature for the tape cartridges, routines can be executed within the Spectra Logic tape library shipping container to systematically rewind tape media within tape cartridges after certain time limit of no activity are reached to protect the tape cartridges against temperature extremes. For example, a tape cartridge may be rewound about every 3 months, or some other time interval set by an administrator operator. Moreover, this continuous maintenance can provide the added benefit of identifying problematic tape cartridges for replacement.

As mentioned earlier, certain other embodiments contemplate that the shipping containers are standard shipping containers that are agnostic to storage systems that can be either used or new. The standard shipping containers can be retrofitted with the componentry that make up the tape library system integrated therein. Unlike all other tape libraries today, tape library shipping container storage systems can be constructed whereby an empty shipping container/housing is provided and the tape library frame is constructed inside of the shipping container. The inherent rigidity of the shipping container can be used to provide rigidity to the frame bolted, or otherwise fixedly attached, to the different surfaces within the shipping container. Accordingly, the shipping container is provided empty followed by constructing the library frame within the shipping container, followed by installing the robotic transport system, etc. Certain embodiments envision a vibration dampening floor within the shipping container on which that the library frame rests to mitigate vibration caused either internally or externally. Certain other embodiments envision components of the frame being fixedly attached to the shipping container, such as by welding or bolting, for example. Yet other embodiments envision the shelf system being fixedly attached to the sides or ceiling or both the sides and ceiling of the shipping container. Hence, the shipping container is an integral part of the tape library system.

Yet other embodiments contemplate a self-sufficient powered shipping container that utilizes solar power integrated on the top surface of the shipping container to collect solar energy when the self-sufficient powered shipping container is that is located in an exterior environment. Unlike other kinds of storage systems, the tape library shipping container system utilizes power to move robotic systems and operate tape drives, which is far lower energy consumption than systems that primarily use hard disk drives as library storage, for example.

Other certain embodiments envision a fire suppression system being comprised by the tape library shipping container system. Fire suppression system can be outside of the container with standard hydration systems, or optionally internally whereby nitrogen or some other non-oxygenated gas can be infused within the tape library shipping container system to prevent fire generation, just to name several examples.

One embodiment contemplate shipping the tape library shipping container system loaded with tape cartridges. This embodiment envisions a retaining system that prevents each of the tape cartridges, or tape magazines, from falling out of the shelf system during transport.

Because an operator will likely have to enter the shipping container, robot disabling systems can be employed for operator safety. One embodiment envisions a gate that when opened to allow an operator to access tape drives and or the Entry/Exit ports blocks the robot transporter from moving into the space used by the operator.

The shipping container tape library system can, in certain embodiments, comprise multiple dependent, co-communitive, coexisting, or independent libraries in the same shipping container.

The shipping container tape library system in certain embodiments can further include a server system generally comprised of solid state drives or hard disk drives, or reasonable equivalent.

Though not described in detail, the shipping container tape library system contains all the general purpose networking switches, safety measure for serviceability, library and robotic controllers, computing equipment, tape drive interface servers, network switches, fans, lights, etc. that are generally needed to render the tape library system functional. Further embodiments envision the shipping container tape library system supporting any tape drive technology that can be utilized in any generation, various protocol, various electrical hookups and HVAC hookups.

Embodiments envision a plurality of shipping container tape library systems being disposed next to one another, linked side-by-side, and stacked on top of one another, just to name several placement options. Moreover, multiple shipping container tape library systems are envisioned to double as other support structures for greater system, such as bridges, walls, floors, buildings, etc.

Though the embodiments described herein are directed to tape cartridges, which are one type of removable/mobile media, certain other embodiments envision another type of removable/mobile media adapted to be moved between a shelf system and drives with robotic systems, such as the transporter and picker. One such example includes standalone optical disks that can be inserted in optical disk drives in the same manner as tape cartridges are inserted in tape drives. In other words, some embodiments contemplate standalone removable disks, such as compact discs or DVDs, and the like, substituting tape cartridges in the present invention.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed.

What is claimed is:

1. A method of constructing a freight container library, the method comprising:
providing a freight/shipping container possessing a base, a ceiling, a front, a back, and two side walls;
after providing said shipping container, affixing a shelf system adapted to support tape cartridges to at least one sidewall of said freight/shipping container;
affixing a tape drive support structure adapted to support tape drives to at least one of said sidewalls;
affixing at least one robotic transporter rail that extends between said front and said back; and
connecting at least one robotic transporter to said robotic transporter rail.

2. The method of claim 1 wherein the freight/shipping container is a standard shipping container possessing standard shipping container dimensions.

3. The method of claim 1 wherein said shipping container is box shaped and said sidewalls are rectangular.

4. The method of claim 1 wherein said robotic transport rail is affixed to said base by way of an intermediate internal frame.

5. The method of claim 1 wherein said shelf system and said tape drive support structure are affixed to said at least one sidewall by way of an intermediate internal frame.

6. The method of claim 1 further comprising loading a plurality of tape cartridges into said shelf system.

7. The method of claim 6 further comprising retaining said plurality of tape cartridges in said shelf system with a latch mechanism.

8. The method of claim 1 further comprising installing a plurality of tape drives in said tape drive support structure.
